(19) United States
(12) Patent Application Publication
(10) Pub. No.: US 2026/0152229 A1
(43) Pub. Date: Jun. 4, 2026

(54) ROTARY SENSOR AND STEERING SYSTEM FOR A MOTOR VEHICLE

(71) Applicants: thyssenkrupp Presta AG, Eschen (LI); thyssenkrupp AG, Essen (DE)

(72) Inventor: Adrian CAMPOS, Grabs (CH)

(73) Assignees: thyssenkrupp Presta AG, Eschen (LI); thyssenkrupp AG, Essen (DE)

(21) Appl. No.: 19/406,543

(22) Filed: Dec. 2, 2025

(30) Foreign Application Priority Data
Dec. 3, 2024 (BE) BE 2024/5852

(51) Int. Cl. B62D 15/02

(52) U.S. Cl. CPC B62D 15/022

(57) ABSTRACT

A rotary sensor for a steering system of a motor vehicle comprises a ring gear which is rotatably mounted in a housing about an axis (A), having an internal toothing, and a coupling element designed for connection to a steering shaft that can be rotated about its longitudinal axis (L), wherein the housing has an axial end wall, an axial inner wall, and a coaxially running circumferential wall, wherein the ring gear is arranged axially between the end wall and the inner wall and is circumferentially enclosed by the circumferential wall with respect to the axis (A), and wherein at least one measuring wheel, which has a magnetic element, is rotatably mounted in the housing and meshes with its external toothing in the internal toothing of the ring gear, and wherein measuring elements cooperating with the magnetic elements of the measuring wheel are mounted in the housing. In order to improve operational safety and to enable a more compact design, the end wall and the inner wall may be formed continuously closed over an interior enclosed by the internal toothing.

### CROSS REFERENCE TO RELATED APPLICATION

This application is a U.S. Non-Provisional that claims priority to Belgian Patent Application No. BE 2024/5852, filed Dec. 3, 2024, the entire content of which is incorporated herein by reference.

### FIELD

The present disclosure relates to a rotary sensor for a steering system of a motor vehicle.

### BACKGROUND

In a steer-by-wire steering system of a motor vehicle, an electric rotary sensor detects the rotation of a steering shaft, for example the steering spindle of a steering column, generated by manual actuation of a steering handle. From the angle measured values, electrical control signals are generated to control an electric steering drive, which causes a corresponding steering angle of the steered wheels. By means of such a rotary sensor, the rotation of another steering shaft, this is a shaft acting directly or indirectly with the steering, can also be measured.

For example, a generic rotary sensor is described in JP 2009262848 A. This comprises a ring gear coupled to the steering shaft with an internal toothing running about an axis. Inside the ring gear are arranged two measuring wheels, which have different numbers of teeth and are in toothed engagement with the ring gear. Each of the measuring wheels has a co-rotating magnetic element, the angle-dependent magnetic field of which is detected by an assigned measuring element fixed relative to the housing. From the measured magnetic fields of the two measuring wheels, the angular position of the ring gear and thus of the steering shaft can be determined unambiguously over several revolutions.

In the known rotary sensor, the ring gear is housed in a housing together with the measuring wheels and the measuring elements. It comprises an end wall axially arranged in front of the ring gear, an inner wall axially arranged on the other side of the ring gear, and a circumferential wall or casing wall arranged between the end and inner wall and running around the ring gear, thereby delimiting a housing interior space. The steering shaft is axially guided through central bearing openings of the inner wall and the end wall and is rotatably mounted in it. Inside the housing, the ring gear is fixed to the steering shaft by means of a hub in a rotationally fixed manner. This means that all functional elements of the sensor are integrated in the housing. However, it is disadvantageous that the rotatable steering shaft is passed through the housing interior, in which the measuring wheels are accommodated together with the sensor electronics. The bearings of the steering shaft can allow potentially harmful external influences to enter and impair the function. Furthermore, the functional elements must be arranged in a protected position relative to the ring gear rotating in the interior. This results in a relatively large installation space requirement, which is also perceived as a disadvantage.

In the prior art, versions with a measuring wheel are also known.

Thus a need exists to enable improved operating safety and a more compact design.

### BRIEF DESCRIPTION OF THE FIGURES

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 shows a schematic illustration of a steer-by-wire steering system according to the disclosure.

FIG. 2 shows a schematic perspective view of a rotary sensor of the steering column according to FIG. 1.

FIG. 3 shows a further view of the rotary sensor according to FIG. 2.

FIG. 4 shows a partially open view of the rotary sensor according to FIG. 3.

FIG. 5 shows a longitudinal section through the rotary sensor according to FIGS. 2 to 4.

### DETAILED DESCRIPTION

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents. Moreover, those having ordinary skill in the art will understand that reciting “a” element or “an” element in the appended claims does not restrict those claims to articles, apparatuses, systems, methods, or the like having only one of that element, even where other elements in the same claim or different claims are preceded by “at least one” or similar language. Similarly, it should be understood that the steps of any method claims need not necessarily be performed in the order in which they are recited, unless so required by the context of the claims. In addition, all references to one skilled in the art shall be understood to refer to one having ordinary skill in the art.

The disclosure relates to a rotary sensor for a steering system of a motor vehicle, comprising a ring gear, which is rotatably mounted in a housing about an axis, and an internal toothing and a coupling element designed for connection to a steering shaft that can be rotated about its longitudinal axis, wherein the housing has an axial end wall, an axial inner wall, and a coaxially running circumferential wall, wherein the ring gear is arranged axially between the end wall and the inner wall and is circumferentially enclosed by the circumferential wall with respect to the axis, and wherein at least one measuring wheel, which has a magnetic element, is rotatably mounted in the housing and engages with its external toothing in the internal toothing of the ring gear, and wherein measuring elements cooperating with the magnetic element of the measuring wheel are mounted in the housing. A steering system for a motor vehicle with such a rotary sensor is also a subject of the disclosure.

In a rotary sensor for a steering system of a motor vehicle, comprising a ring gear which is rotatably mounted in a housing about an axis, and an internal toothing and a coupling element designed for connection to a steering shaft that can be rotated about its longitudinal axis, wherein the housing has an axial end wall, an axial inner wall, and a coaxially running circumferential wall, wherein the ring gear is arranged axially between the end wall and the inner wall and is circumferentially enclosed by the circumferential wall with respect to the axis, and wherein at least one measuring wheel, which has a magnetic element, is rotatably mounted in the housing and engages with its external toothing in the internal toothing of the ring gear, and wherein measuring elements cooperating with the magnetic elements of the measuring wheel are mounted in the housing, it is provided in accordance with the invention that the end wall and the inner wall are formed continuously closed over an interior enclosed by the internal toothing.

Preferably, it can be provided that at least two measuring wheels are rotatably mounted in the housing, each having a magnetic element, and each engage with their external toothing in the internal toothing of the ring gear, and wherein measuring elements cooperating with the magnetic elements of the measuring wheels are mounted in the housing. The two measuring wheels have different numbers of teeth and thus enable the realization of a nonius measuring principle. As far as the measuring wheels are mentioned below, this should include both versions with one and with two or more measuring wheels.

In the following, a steering shaft is generally understood to be a rotatable or rotatably driven shaft of a motor vehicle steering system, the rotation of which can be detected by the rotary sensor. The steering shaft may comprise, for example, a manually rotatable steering spindle of a steering column, preferably a steer-by-wire steering column, but is not limited to it. The internal toothing is formed running coaxially around the axis on the inner circumference of the ring gear. The at least two measuring wheels, which have external toothings with different numbers of teeth, are rotatably mounted in toothed engagement in the interior of the ring gear, within the internal toothing. The interior enclosed by the ring gear can also be referred to synonymously as a passage of the internal toothing or as a passage for short. It is quite conceivable and possible that this passage is axially closed by a completely or partially continuous wall. In this case, the interior of the ring gear could be pot-shaped, which is axially open towards the inner wall.

The end wall of the housing is arranged axially outwards with respect to the ring gear and is closed continuously according to the invention. It thus forms an outer housing wall, which has no continuous through-holes, in contrast to the prior art with the through-wall bearing bore for the steering shaft. The end wall is connected to a circumferential wall of the housing, which can be tubular, preferably hollow-cylindrical. On the opposite axial side, the housing has the inner wall. This means that the ring gear is arranged axially between the inner wall and the end wall. Accordingly, the housing interior, in which the ring gear is rotatably mounted, is axially delimited by the end wall and radially by the circumferential wall.

The ring gear has a ring-shaped ring gear of which the internal toothing encloses an axially open inner cross-section on both sides over the circumference and is thus radially delimited outwards with respect to the axis. The interior extends transversely to the axis over the inner cross-section of the ring gear enclosed by the internal toothing, and axially, i.e., in the axis direction between the opposed, according to the invention continuously closed, axial faces of the inner wall and the end wall.

The axial width of the interior is thus greater than or equal to the axial width of the internal toothing.

Accordingly, the interior between the front and the inner wall is substantially cylindrical. Its free, substantially circular disc-shaped passage cross-section can be measured between the radially inwardly projecting tooth tips of the internal toothing.

According to the invention, the end wall and the inner wall cover the interior of the ring gear axially continuously. In this case, they have no openings or apertures in the area of the passage cross-section of the ring gear, i.e., the internal toothing. In particular, no central, axially continuous bearing opening is provided for a steering shaft. In the prior art mentioned above, this extends through the inner wall and the end wall.

An advantage of the arrangement according to the invention is that the entire interior of the ring gear is available for the arrangement of the functional elements of the sensor arrangement, for example for the arrangement and storage of the measuring wheels, the arrangement of the measuring elements cooperating therewith, as well as the arrangement and design of electrical circuits and the like cooperating therewith. This results in greater design freedom, and the possibility of a reduction in installation space and functional optimization.

Another advantage is that the entire measuring arrangement including the measuring wheels, the measuring elements and the electrical circuits can be accommodated better protected against potentially harmful external influences in the interior of the ring gear, for example against the ingress of impurities through the bearing openings of the steering shaft.

As the ring gear in the housing interior has no hub connected to the steering shaft, the interior enclosed by the ring gear is free of rotating parts, so that no protective measures are required as in the prior art and a more compact design is accordingly possible.

It is also advantageous that an optimized mounting of the rotary sensor on an axial end of a steering shaft is possible. To do this, it is only necessary to allow the transmission of torque from an axial end of the steering shaft to the ring gear.

The following are examples of advantageous solutions. These enable in particular an advantageous integration of the rotary sensor in a steer-by-wire steering column, in which the steering shaft comprises a manually rotatable steering spindle, which is not mechanically connected to the steerable wheels. In this case, preferably at the front end of the steering spindle, a rotary sensor according to the invention for detecting manual steering commands can be mounted.

Preferably, the ring gear may have an axial passage delimited circumferentially by the internal toothing. The ring gear can be a ring-shaped, open ring gear. Its free passage cross-section can preferably be limited substantially by the internal toothing, i.e., exclusively by the tooth surfaces. Since the steering shaft is not carried out through the interior space between the front and inner wall, the ring gear in the interior space has no hub connected to the steering shaft, and the interior space is advantageously free of rotating parts.

It is advantageous that the ring gear is sealed axially against the end wall and/or the inner wall. The sealing can preferably be realized by annular sealing elements running outside around the interior in a ring shape coaxially about the axis, which are arranged between axially opposite surfaces of the ring gear and the inner wall or/and the end wall. Such a sealing element may comprise, for example, an axial seal, for example, having a sealing ring which revolves around the axis with a predetermined radius. Preferably, it may be designed to allow a low-friction rotation of the ring gear relative to the housing.

It may be provided that the ring gear is mounted in an axial bearing arrangement on the end wall and/or the inner wall. Such an axial bearing arrangement enables a rotatable bearing without a centrally continuous, radial bearing element, as is realized in the prior art by the central continuous bearing holes in the end wall and the inner wall. In contrast, the axial bearing arrangement does not have a central bearing bore. The end wall and/or inner wall is closed in the area of the axle. The axial bearing arrangement may be formed in or on the axially opposite axial surfaces of the ring gear and the end wall or the inner wall. For example, an axially projecting, coaxial annular projection may be arranged on an axial surface, which engages in a corresponding annular groove in the opposite axial surface. A ring projection and/or a ring groove can be simply formed on one or both axial sides on an annular ring gear. Alternatively, a spigot-like axially projecting central bearing projection may be provided, which engages in a corresponding concave injection of the ring gear, which, however, has no axially continuous opening through the end or inner wall. The advantage of such an axial bearing arrangement is that the interior of the ring gear can be covered by the end wall and the inner wall in a continuously closed manner, and in particular no continuous bearing holes are present as in the prior art.

An axial bearing can be realized by the fact that the inner wall is rotatably inserted in a bearing recess of the ring gear. In this embodiment, the inner wall itself may be formed as a kind of axial cover, which is inserted form-fittingly into an axial bearing recess of the ring gear, which is formed running around the interior. In other words, the ring gear is mounted on the inner wall itself and can be rotated. In this case, bearing surfaces can be arranged on the externally running circumferential surface and an axial surface lying in the edge area. The advantage is a simple design with few components, and a completely safely closed interior.

It is possible that the inner wall is connected to the end wall via at least one connecting means passing axially through the interior. The opposite inner sides of the end wall and the inner wall, which delimit the interior space axially on both sides, can be connected, for example, by one or more connecting elements. For example, the end wall may have one or more axial projections on which the inner wall is axially supported and fixed. Preferably, the connecting means can be configured to position the inner wall relative to the end wall at a defined axial distance, so that a rotary bearing of the axially arranged between ring gear is possible. An advantageous compact design with relatively few components is made possible.

An advantageous embodiment can provide that a coaxial, axially open annular gap is formed around the outside of the inner wall. The annular gap preferably has a circular axial passage cross-section and can be arranged circumferentially between an outer circumference of the inner wall and a hollow-cylindrical inner circumference of the housing. The inner circumference may be formed on the radial inner side of the casing or circumferential wall of the housing, which limits the receiving space of the housing. In the receiving space, the ring gear is arranged, for example axially adjacently, such that a coupling element for connecting the ring gear to a steering shaft which can be rotated about its longitudinal axis can be arranged in the annular gap. The coupling element may be formed in the region of the annular opening cross-section of the annular gap from the axial inner side of the ring gear. One or more coupling elements may be provided which extend axially from the ring gear through the annular gap. On the drive side, i.e., on the axial side of the inner wall facing away from the ring gear, a steering shaft that can be driven by rotation can be rotatably connected to the coupling element. Thus, a rotational movement to be measured can be advantageously coupled into the ring gear.

In the above-mentioned design, it may be provided that the coupling element extends axially through the annular gap. The coupling element is designed for coupling a torque from a steering shaft, which is arranged on the axial side of the inner wall facing away from the ring gear. This may, for example, have a shaft end axially directed against the inner wall, such as the front end of a steering spindle of a steer-by-wire steering column. An advantageous embodiment can be realized, for example, in that a ring gear, for example an inner ring gear, with which a drive wheel connected to the steering shaft or steering spindle is in toothed engagement, is connected through the ring gap to the ring gear. It may preferably be provided that the coupling element is formed in one part or one-piece with the ring gear. Alternatively, it is also possible that the coupling element allows a torque-locked coupling engagement between the steering shaft and the ring gear, for example in the manner of a pin or claw coupling known per se. This can pass at least indirectly through the annular gap in the axial direction.

It is advantageous that the housing is pot-shaped. The housing may have a pot-, cup- or hood-shaped basic shape, which is formed from the closed end wall according to the invention and the associated, substantially tube-section-shaped, preferably hollow-cylindrical circumferential wall. The preferably cylindrical interior may be delimited on the drive side axially facing away from the end wall by the inner wall designed in accordance with the invention. In this case, the inner wall may be mounted within the housing or at least adjacently to it for the realization of a compact, protected design.

It may be provided that the end wall together with the circumferential wall is formed in one piece. A one-piece design can be realized, for example, by a metal die-cast part or a plastics injection-molded part, a sheet metal molded part or the like and enables efficient production.

It is possible that the housing has fasteners. The fastener(s) are used for fastening to a motor vehicle steering system, for example for attachment to a steering column. Preferably, these are arranged externally on the housing, for example as a mounting flange, which can have projections arranged on the end wall or the circumferential wall, with flange holes or the like. The fasteners can be formed in one piece with the housing, for example in the die-cast or injection molding process. This enables efficient production and easy assembly, for example by end-side flange-mounting on the steering column.

It is preferably possible that the measuring wheels are mounted on the end wall. On the inner side facing the ring gear, bearing elements configured or designed for the bearing of the measuring wheels may be attached to the end wall, for example bearing journals projecting into the interior of the ring gear, on which the measuring wheels are rotatably mounted. This makes it possible to mount the measuring wheels easily by fitting them axially onto the bearing journals. The toothed engagement with the internal toothing of the ring gear can be created. For efficient production, it is advantageous that the bearing elements, for example axial bearing journals, are shaped in one piece on the end wall, for example in the die-cast or injection molding process.

An advantageous development can be realised in that the inner wall has a circuit board. A circuit board generally refers to an electrical circuit board, preferably as a single-or multi-layer printed circuit board, which serves as a carrier for components of an electronic circuit and on an insulating plate arranged electrical traces for interconnecting the components. The components may include, among other things, the measuring elements or sensor elements for measuring the angle-dependent magnetic field mounted on the measuring wheels. The components may preferably be arranged on the inside of the circuit board facing the interior of the ring gear, where they are protected in the interior of the ring gear, which interior is closed according to the invention. The advantages are that, in addition to the function as a mechanical carrier and electrical connecting means of the sensor circuit, the printed circuit board can assume all functions of the interior wall according to the invention, to close the interior and support and/or bear the ring gear axially. As a result, the outlay in terms of manufacture and assembly can be reduced.

It is possible that the circuit board extends flat perpendicular to the axis and is circular, i.e., circular disk-shaped.

The invention comprises a steering system for a motor vehicle, comprising a steering shaft which can be rotated about its longitudinal axis, which is operatively connected to a rotary sensor for detecting a rotation, in which it is provided according to the invention that the rotary sensor is designed with the features according to one or more of the embodiments described above.

In particular, it is possible that the steering shaft is a steering spindle of a steer-by-wire steering column, and the rotary sensor is coupled to a front end region of the steering spindle. This enables an advantageous integration of the rotary sensor in a steer-by-wire steering column, in which the steering shaft comprises a manually rotatable steering spindle, which is not mechanically connected to the steerable wheels with its front end facing away from the driver's position with respect to the direction of travel. Instead, preferably at the front end of the steering spindle, a rotary sensor according to the invention for detecting manual steering commands can be mounted.

In the various figures, the same parts are always provided with the same reference signs and therefore are generally also only referred to or mentioned once in each case.

FIG. 1 schematically shows a steer-by-wire steering system 1, which comprises a steering column 2. This has a support unit 21 which can be mounted on a vehicle body (not shown), of which a steering spindle 22 is rotatably mounted about its longitudinal axis L in a casing unit 24. A steering wheel 23 is mounted in a rotationally fixed manner on the steering spindle 22 at the rear, driver-side end of the steering spindle for entering manual steering commands.

The steering spindle 22 represents a steering shaft in the sense of the invention.

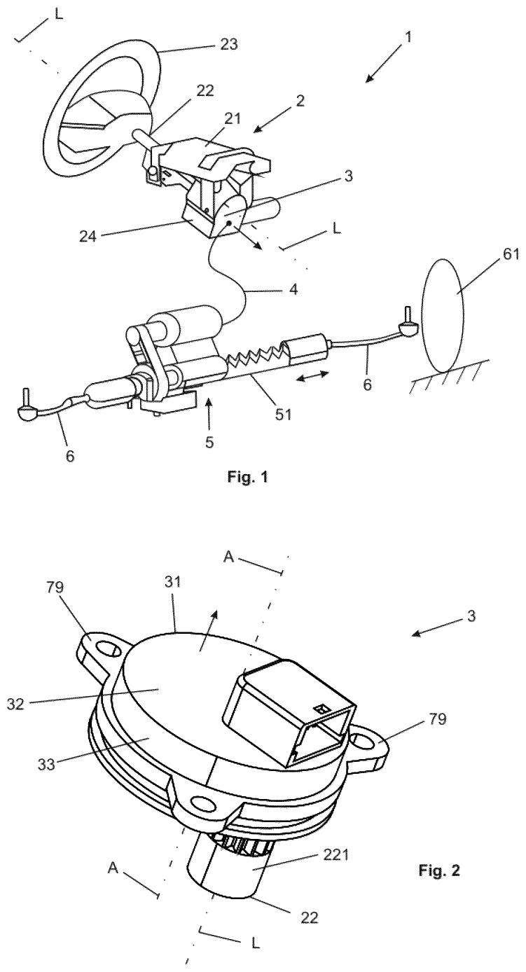

On the steering column 2, a rotary sensor 3 according to the invention is mounted, which detects a steering command introduced into the steering spindle 22 as rotation of the steering wheel 23, this being schematically indicated in FIG. 1 and is explained in detail in the illustrations of FIGS. 2 to 5.

The steering input from the rotary sensor 3 is detected by a control unit in an electrical control signal, namely a steering signal, which is transmitted via an electrical control line 4 to an electric steering actuator 5.

The steering actuator 5 has an electro-motor linear drive, for example, a spindle drive known per se or the like. By this, an actuator rod 51 can be moved linearly depending on the activation by electrical steering signals, as indicated by the double arrow.

Via tie rods 6, the actuator rod 51 is hinged in a known manner to the steering knuckles of steerable wheels 61.

The rotary sensor 3 according to the invention is connected to a front end section 221 facing away from the steering wheel 23 in the direction of travel of the vehicle with the steering spindle 22, which is directed diagonally to the right downwards in the view of FIG. 1. This forward direction of the longitudinal axis L is indicated by the arrow.

In the example shown, the rotary sensor 3 mounted on the steering spindle can also be used in principle at other points in the steering system 1, for example to detect the rotation of the pinion 25 in order to determine the position of the toothed rack.

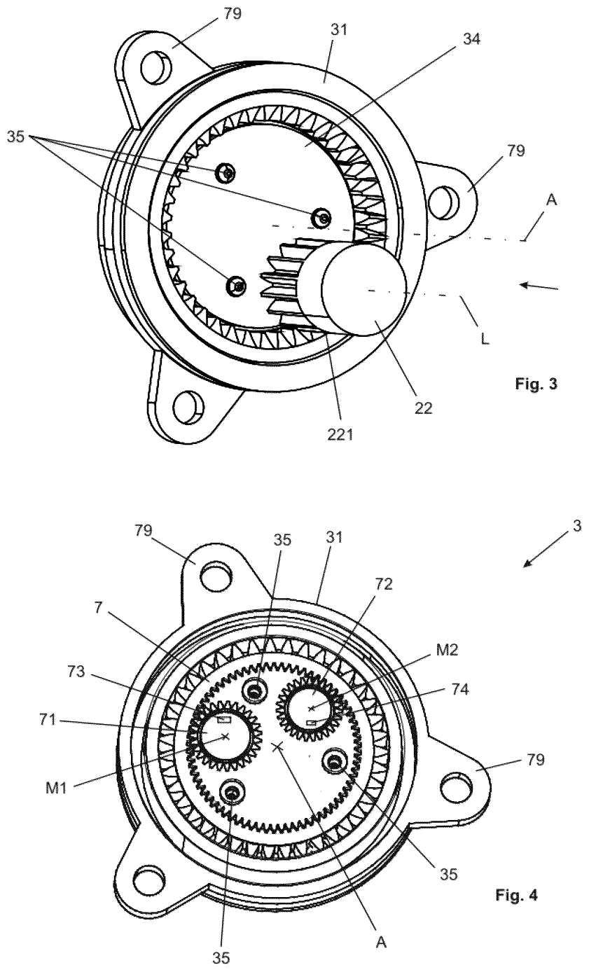

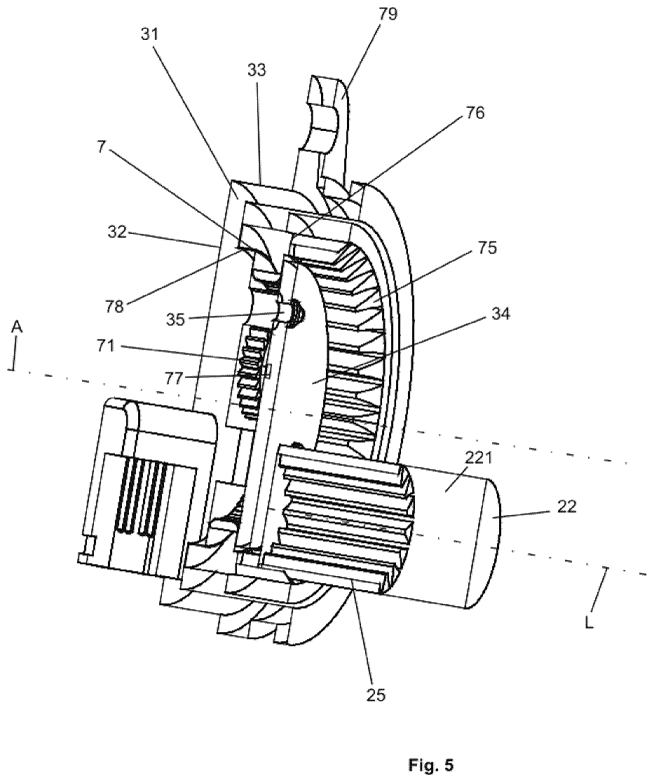

In the illustrations of FIGS. 2, 3, 4 and 5, the rotary sensor 3 is shown individually on its own. FIG. 2 is a perspective view of the front side, namely obliquely to the longitudinal direction of the longitudinal axis L, which is drawn with the arrow. FIG. 3 shows a perspective view diagonally from behind, which is partially dismantled in FIG. 4. FIG. 5 shows in perspective view a longitudinal section along the longitudinal axis L.

The rotary sensor 3 has a pot-or cup-shaped housing 31, with an axially outlying end wall 32, which is connected to a circumferential wall 33 which is hollow-cylindrical around an axis A and which can also be referred to as a casing wall. The end wall 32 is designed to be continuously closed according to the invention, in particular in the region of the longitudinal axis L and the axis A.

In the housing 31, a ring gear 7 is rotatably mounted around the axis A with an internal toothing running coaxially around this axis A, as can be seen in FIGS. 4 and 5. The internal toothing encloses an interior of the ring gear 7 with its axial passage. This is closed to the front in the longitudinal direction by the end wall 32, and on the opposite axial inside by a circular disc-shaped inner wall 34. The ring gear 7 is thus arranged axially between the end wall 32 and the inner wall 34.

In the illustration of FIG. 4, the inner wall 34 is omitted for a better overview. Two measuring wheels 71 and 72 are rotatably mounted around their axes M1 and M2 in the interior, which can be viewed freely, and engage in the internal toothing in toothed engagement. The axes M1 and M2 are arranged parallel to the axis A with a radial distance.

The two measuring wheels 71 and 72 have different numbers of teeth, and each carry a co-rotating magnetic element 73 and 74, as can be seen in FIG. 4.

The inner wall 34 is fixed to the end wall 32 by means of fasteners 35, which extend axially through the interior. The fasteners 35 to the end wall 32 have molded pins or the like, which protrude axially in the direction of the axis A into the interior. The inner wall 42 can be fixed onto these, as can be seen in FIG. 3.

Like the end wall 32, the inner wall 34 in the central area of the axis A is formed continuously closed.

According to the invention, the interior of the ring gear 7 is delimited and closed by the end wall 32 and the inner wall 34 and the outer circumferential internal toothing.

The longitudinal axis L of the steering spindle 20 is arranged in the example with a radial distance parallel to the axis A of the ring gear 7, as can be easily seen in FIGS. 3 and 5.

A pinion 25 is mounted on the steering spindle 22 in the front end section 221. This engages with its external toothing in the internal toothing of a drive wheel 75. This has an inner ring gear rotating coaxially around the axis A and axially coupled for conjoint rotation to the ring gear 7 through an annular gap 76 running coaxially around the axis A and formed between the inner wall 34 and the housing 31, said annular gap being shown in FIG. 5. Thus, a rotation of the steering spindle 22 about the longitudinal axis L is converted into a rotation of the drive wheel 75 and the ring gear 7 coupled thereto.

The coupling element between the drive wheel 75 and the ring gear 7 can be realized, for example, by means of a one-piece connection, for example by means of a one-piece plastic injection-molded part. Alternatively, it is also conceivable and possible that a releasable coupling engagement between the steering spindle 22 and the ring gear 7 is realized, for example by form-fitting elements, which axially engage through said annular gap 76.

The inner wall 34 may comprise a circuit board, i.e., a circuit board made of an insulating material with electrical conductive tracks, which serves as a carrier for an electronic control circuit. This can preferably be arranged on the inner face facing the ring gear 7 in the interior, and can preferably also have measuring elements 77 associated with the magnetic elements 73 and 74, as indicated in FIG. 5.

The ring gear 7 can be rotatably mounted on the inner wall 34, such as in the example shown in that the inner wall 34 is circular and engages axially in a coaxial recess of the ring gear 7. A similar axial bearing may be realized by a coaxial projection 78 which axially projects from the end wall 32 and on which the ring gear 7 is rotatably mounted. This can be molded in one piece onto the housing 31.

The housing 31 may comprise connecting means for mounting on the steering column 2, for example a flange 79 or the like. This can also be molded on in one piece.

### LIST OF REFERENCE SIGNS

1 Steering system
2 Steering column
21 Support unit
22 Steering spindle
221 End section
23 Steering wheel
24 Casing unit
25 Pinion
3 Rotary sensor
31 Housing
32 End wall
33 Circumferential wall
34 Inner wall
35 Fastener
4 Control line
5 Steering actuator
51 Actuator rod
6 Track rod
61 Wheel
7 Ring gear
71, 72 Measuring wheel
73, 74 Magnetic element
75 Drive wheel
76 Annular gap
77 Measuring element
78 Projection
79 Flange
L Longitudinal axis
A Axis
M1 Axis
M2 Axis

1. A rotary sensor for a steering system of a motor vehicle, comprising:
a ring gear which is rotatably mounted in a housing about a rotary axis and includes an internal toothing; and
a coupling element designed for connection to a steering shaft that can be rotated about its longitudinal axis;
rotary axis;
; [symbol]
;
wherein the end wall and the inner wall are formed continuously closed over an interior enclosed by the internal toothing.

2. The rotary sensor as claimed in claim 1, wherein in the housing at least two measuring wheels are rotatably mounted, each having a magnetic element, and in each case with their external toothing engage in the internal toothing of the ring gear, and wherein measuring elements cooperating with the magnetic elements of the measuring wheels are mounted in the housing.

3. The rotary sensor as claimed in claim 1, wherein the ring gear has an axial interior space delimited on the circumferential side by the internal toothing.

4. The rotary sensor as claimed in claim 1, wherein the ring gear is axially sealed against the end wall and/or the inner wall.

5. The rotary sensor as claimed in claim 1, wherein the ring gear is mounted in an axial bearing arrangement on the end wall and/or the inner wall.

6. The rotary sensor as claimed in claim 1, wherein the inner wall is rotatably inserted in a bearing recess of the ring gear.

7. The rotary sensor as claimed in claim 1, wherein the inner wall is connected to the end wall via at least one connecting means passing axially through the interior.

8. The rotary sensor as claimed in claim 1, wherein a coaxial, axially open annular gap is formed around the outside of the inner wall.

9. The rotary sensor as claimed in claim 8, wherein the coupling element extends through the annular gap.

10. The rotary sensor as claimed in claim 1, wherein the housing is pot-shaped.

11. The rotary sensor as claimed in claim 1, wherein the end wall together with the circumferential wall is formed in one piece.

12. The rotary sensor as claimed in claim 1, wherein the housing has fasteners.

13. The rotary sensor as claimed in claim 1, wherein the measuring wheels are mounted on the end wall.

14. The rotary sensor as claimed in claim 1, wherein the inner wall or the housing has a circuit board.

15. A steering system for a motor vehicle, comprising:
a steering shaft which can be rotated about its longitudinal axis, which is operatively connected to a rotary sensor for detecting a rotation;
the rotary sensor is formed as claimed in claim 1.
